(19) United States
(12) Patent Application Publication
(10) Pub. No.: US 2022/0141328 A1
(43) Pub. Date: May 5, 2022

(54) EMERGENCY REPORTING SYSTEM AND METHOD FOR THE SOCIALLY DISADVANTAGED

(71) Applicant: ELECTRONICS AND TELECOMMUNICATIONS RESEARCH INSTITUTE, Daejeon (KR)

(72) Inventors: Myung Sun BAEK, Daejeon (KR); Won Joo PARK, Daejeon (KR); Seung Hi KIM, Daejeon (KR); Yong Jin KIM, Daejeon (KR); Young Soo PARK, Daejeon (KR); Jun Seong BANG, Daejeon (KR); Sang Yun LEE, Daejeon (KR); Yong Tae LEE, Daejeon (KR); Eui Suk JUNG, Daejeon (KR)

(73) Assignee: ELECTRONICS AND TELECOMMUNICATIONS RESEARCH INSTITUTE, Daejeon (KR)

(21) Appl. No.: 17/517,437

(22) Filed: Nov. 2, 2021

(30) Foreign Application Priority Data
Nov. 2, 2020 (KR) 10-2020-0144432
Oct. 21, 2021 (KR) 10-2021-0141245

(51) Int. Cl. H04M 1/72424; H04M 1/72421; H04W 4/90; G06F 40/58; G06N 20/00

(52) U.S. Cl. CPC H04M 1/72424; H04M 1/72421; G06N 20/00; G06F 40/58; H04W 4/90

(57) ABSTRACT

The present invention relates to an emergency reporting system and method for the socially disadvantaged. The emergency reporting system for the socially disadvantaged according to the present invention includes a user terminal configured to receive an emergency report input in a preset manner according to environment information set by the socially disadvantaged, generate an emergency report message, and transmit the emergency report message, and a server configured to receive the emergency report message and transmit a dispatch notification signal.

### CROSS-REFERENCE TO RELATED APPLICATION

This application claims priority to and the benefit of Korean Patent Applications No. 10-2020-0144432, filed on Nov. 2, 2020 and No. 10-2021-0141245, filed on Oct. 21, 2021, the disclosure of which is incorporated herein by reference in its entirety.

### BACKGROUND

### 1. Field of the Invention

The present invention relates to an emergency reporting system and method for the socially disadvantaged.

### 2. Discussion of Related Art

Services in which an SOS message is transmitted to a contact that is pre-specified by a user by pressing a side button of his or her smartphone several times in case the user is in an emergency situation (e.g., assault, robbery, sexual harassment, etc.) are provided.

However, the socially disadvantaged, such as the visually impaired, the hearing impaired, foreigners residing in Korea, and the like, have limitations in using such an emergency reporting service, and there is a problem in that it is difficult for an organization (e.g., the National Police Agency) that receives reports to accurately recognize a current situation of the user.

### SUMMARY OF THE INVENTION

In order to solve the above problems, the present invention is directed to providing a system and method capable of supporting the socially disadvantaged, such as the visually impaired, the hearing impaired, and foreign residents who are not fluent in Korean, to report an emergency situation according to their limitations and receiving content of the report to provide security-related services such as police dispatch and the like.

According to an aspect of the present invention, there is provided an emergency reporting system for the socially disadvantaged which includes a user terminal configured to receive an emergency report input in a preset manner according to environment information set by the socially disadvantaged, generate an emergency report message, and transmit the emergency report message, and a server configured to receive the emergency report message and transmit a dispatch notification signal.

The user terminal may transmit sound information collected using surrounding sounds thereof to the server.

The server may analyze the sound information using artificial intelligence to generate abnormal sign information.

The user terminal may provide an emergency report screen including buttons that are displayed as text according to a user environment set by a hearing-impaired person, and the buttons may include an immediate report button and additional report content buttons.

When a text report button is clicked among the additional report content buttons, the user terminal may transmit the emergency report message including a written text message.

When a preset physical button input is input according to a user environment set by a visually-impaired person, the user terminal may activate an emergency report function and generate the emergency report message according to the preset pattern input.

The user terminal may generate the emergency report message including emergency situation information according to an input of a pattern that is set for each emergency situation type.

The user terminal may perform an automatic call connection with field personnel according to an input of a pattern that is set as a call connection request.

The user terminal may provide an emergency report screen including buttons that are displayed as text translated into a language used according to a user environment set by a foreigner, and the buttons may include an immediate report button and additional report content buttons.

When a call connection request is input among the additional report content buttons, the user terminal may request a call connection from the server and the server may connect a call to personnel who have an ability to speak the language used.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 illustrates an emergency reporting system for the socially disadvantaged according to an embodiment of the present invention;

FIG. 2 illustrates an example of reporting by a hearing-impaired person according to an embodiment of the present invention;

FIG. 3 illustrates an example of reporting by a visually-impaired person according to an embodiment of the present invention;

FIG. 4 illustrates an example of reporting by a foreign resident according to an embodiment of the present invention; and

FIG. 5 is a flowchart of an emergency reporting method for the socially disadvantaged according to an embodiment of the present invention.

### DETAILED DESCRIPTION OF EXEMPLARY EMBODIMENTS

The above-described objects, other objects, advantages, and features of the present invention and methods of achieving the same will be clearly understood with reference to the accompanying drawings and the following detailed embodiments.

However, the present invention is not limited to the embodiments to be disclosed below and may be implemented in various different forms. The following embodiments are merely provided to easily inform those skilled in the art of the objects, configuration, and effects of the present invention. The scope of the present invention is defined by the appended claims.

Meanwhile, terms used herein are provided only to describe the embodiments of the present invention and not for purposes of limitation. In this specification, the singular forms include the plural forms unless the context clearly indicates otherwise. It will be understood that the terms “comprise” and/or “comprising,” when used herein, specify some stated components, steps, operations and/or elements but do not preclude the presence or addition of one or more other components, steps, operations and/or elements.

Hereinafter, in order to aid understanding of those skilled in the art, a background in which the present invention is proposed will be described first and embodiments of the present invention will be described.

According to the World Health Organization, approximately one billion people, one-seventh of the world's population, have a disability.

In Korea, the number of people with disabilities is 2,517,000, accounting for 5% of the total population.

Among the people with disabilities, the visually and hearing impaired, such as the hearing impaired (13.2%) and the visually impaired (9.8%), account for a high proportion.

In addition, the number of foreign residents in Korea has steadily increased, exceeding 2.5 million at the end of 2019, by 6.6% compared to the same period of the previous year.

The socially disadvantaged may be more likely to be exposed to dangerous situations than the general public, and in such a dangerous situation, a customized reporting method and service tailored to the marginal situation of the socially disadvantaged are required.

Currently, the National Police Agency provides a 112 emergency report application or the like. However, when the socially disadvantaged is in an emergency situation, it may be difficult for the socially disadvantaged to use the application effectively because execution of the application and a reporting procedure using the application are complicated.

In addition, it is actually impossible for foreign residents who are not fluent in Korean to perform a 112 report or a report using the application.

The present invention is directed to solving the above-described problem, and a system and method for enabling the socially disadvantaged, such as the disabled, foreign residents, and the like, to easily report a crime by using a smartphone or another personal terminal device is proposed.

According to the present invention, a hearing-impaired person may report an emergency situation using text buttons, a visually-impaired person may report an emergency situation using specific keypress patterns, and a foreigner may effectively report an emergency situation using a preset language translator.

According to the present invention, it is possible to provide a security service for protecting the life, body, and property of the socially disadvantaged who may be vulnerable to crimes.

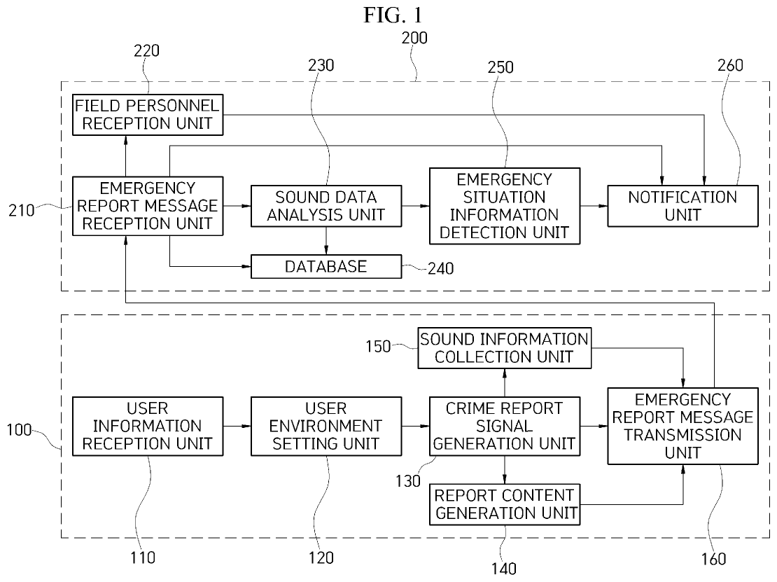

FIG. 1 illustrates an emergency reporting system for the socially disadvantaged according to an embodiment of the present invention.

The emergency reporting system for the socially disadvantaged according to the embodiment of the present invention includes a user terminal 100 that generates a report message and a server 200 that receives the report message.

The server 200 according to the embodiment of the present invention may be a system of the National Police Agency or a security company that receives the report message from the user terminal 100 and determines dispatch of police or field personnel.

The user terminal 100 provides a platform capable of performing an emergency report according to a user environment and mainly provides an application.

The emergency reporting system for the socially disadvantaged according to the embodiment of the present invention includes the user terminal 100 that receives an emergency report input in a preset manner according to environment information set by the socially disadvantaged, generates an emergency report message, and transmits the emergency report message and includes the server 200 that receives the emergency report message and transmits a dispatch notification signal.

The user terminal 100 transmits sound information collected using surrounding sounds thereof to the server 200.

The server 200 analyzes the sound information using artificial intelligence to generate abnormal sign information.

The user terminal 100 provides an emergency report screen including buttons that are displayed as text according to a user environment set by a hearing-impaired person, and the buttons include an immediate report button and additional report content buttons.

When a text report button is clicked among the additional report content buttons, the user terminal 100 transmits the emergency report message including a written text message.

When a preset physical button input is input according to a user environment set by a visually-impaired person, the user terminal 100 activates an emergency report function and generates the emergency report message according to the preset pattern input.

The user terminal 100 generates the emergency report message including emergency situation information according to an input of a pattern that is set for each emergency situation type.

The user terminal 100 performs an automatic call connection with field personnel according to an input of a pattern that is set as a call connection request.

The user terminal 100 provides an emergency report screen including buttons that are displayed as text translated into a language used according to a user environment set by a foreigner, and the buttons include an immediate report button and additional report content buttons.

When a call connection request is input among the additional report content buttons, the user terminal 100 requests a call connection from the server 200 and the server 200 connects a call to personnel who can speak the language used.

A user information reception unit 110 receives user environment information including basic information from a user.

The basic information includes information on basic personal details such as a name, a date of birth, an address, etc. and includes socially disadvantaged information.

A user environment setting unit 120 sets a function of a reporting platform on the basis of the user environment information so that the user can utilize a corresponding emergency report service.

<Case of Hearing-Impaired Person>

When hearing-impaired person information is included in the socially disadvantaged information received by the user information reception unit 110, the user environment setting unit 120 sets the function of the reporting platform so that a text-based emergency report may be performed.

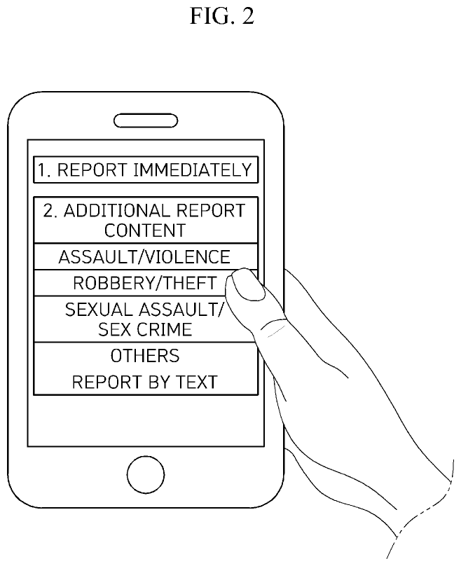

The user environment setting unit 120 sets a text-based report screen so as to be provided through the user terminal, as illustrated in FIG. 2.

In an emergency situation, when the user clicks a “1. Report immediately” button, a crime report signal generation unit 130 generates an emergency report message, and an emergency report message transmission unit 160 transmits the emergency report message to the server 200.

As another example, in the emergency situation, when the user clicks the “1. Report immediately” button, a “2. Additional report content” menu is activated and displayed.

Referring to FIG. 2, menus such as assault/violence, robbery/theft, sexual assault/sex crime, etc. are displayed as pieces of information about emergency situations that occur in general.

The menus displayed when the “2. Additional report content” menu is activated may be changed, added, or deleted.

As the application is executed, the report screen is displayed on the user terminal. When the user clicks the “1. Report immediately” button one time, the “2. Additional report content” menu is activated and displayed, or when the user clicks the “1. Report immediately” button two times consecutively, an immediate dispatch request is performed.

In the case of a situation where additional reporting is possible, the user may click a button included in the “2. Additional report content” menu so as to include more detailed information and may perform an emergency report by including the corresponding emergency situation information.

Further, in the case of a situation in which the user can write a text message, the user may perform the emergency report by clicking a “Report by text” button and inputting information about the emergency situation as text.

When the user clicks the “Report by text” button, a report content generation unit 140 provides a function for attaching photographs and videos in addition to writing the text message and supports the user in performing the emergency report by including various pieces of additional information in addition to the text message.

As described above, when the user clicks the “1. Report immediately” button a preset number of times or clicks the “2. Additional report content,” the emergency report message transmission unit 160 transmits the emergency report message to the server 200.

In this case, a sound information collection unit 150 collects sounds generated in the vicinity thereof using a microphone of the user terminal on the basis of the user consent obtained in advance and transmits information about the sounds generated in the vicinity thereof to the emergency report message transmission unit 160.

The emergency report message transmission unit 160 transmits the emergency report message and the information about the sounds generated in the vicinity thereof to the server 200.

<Case of Visually-Impaired Person>

In the case of a visually-impaired person, the user environment setting unit 120 sets the emergency report function to be activated according to a preset number of inputs for physical buttons (e.g., a power button, a home button, and a volume button).

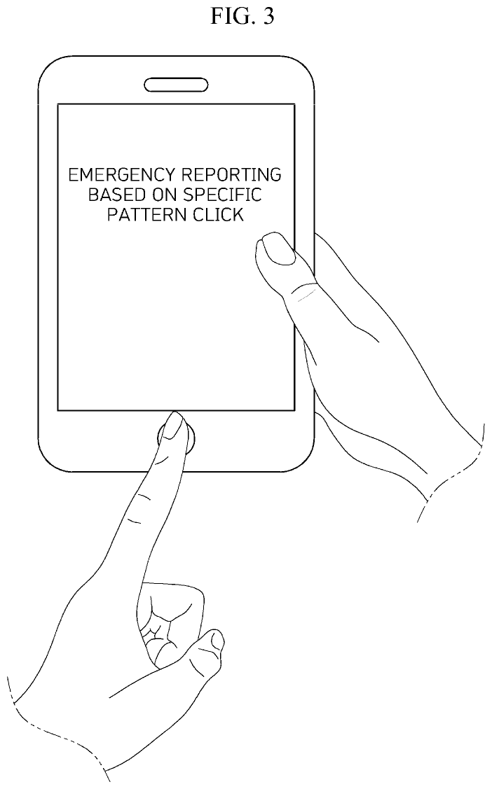

The user environment setting unit 120 sets the emergency report function to be activated when the user inputs a specific pattern using a physical button such as a power button, a home button, a volume button, or the like, as illustrated in FIG. 3.

For example, the user environment setting unit 120 sets the emergency report function to be activated when the visually-impaired person clicks the power button four times consecutively.

When the emergency report function is activated through an input of a preset specific pattern, the user terminal 100 notifies the user that the emergency report function is activated by providing a specific vibration pattern or a specific sound.

For example, the user terminal 100 notifies the user that the emergency report function is activated by providing vibration for one second three times consecutively.

After the emergency report function is activated, the user environment setting unit 120 sets the emergency report function to notify a subject, who receives a report, of additional report content through the input of the preset specific pattern or to communicate with the subject.

For example, by clicking the power button three times consecutively, an emergency situation report for assault/violence is performed, by clicking the home button five times consecutively, an emergency situation report for robbery/theft is performed, by clicking the volume button five times consecutively, an emergency situation report for sexual assault/sex crime is performed, and by clicking the power button five times consecutively, an automatic call connection is performed to a preset number (the number of the subject who receives the report) so that an emergency situation report is performed through a phone call.

The user environment setting unit 120 sets the above-described specific pattern and content of the emergency situation report corresponding thereto.

As in the case of the hearing-impaired person described above, when the pattern for activating the emergency report function is input two times consecutively, the emergency report message transmission unit 160 transmits the emergency report message to the server, and an emergency report message reception unit 210 transmits emergency report reception information to a notification unit 260 and transmits report content to a dispatcher.

Further, when the additional report content is received, the emergency report message transmission unit 160 transmits the emergency report message including the corresponding additional report content to the server 200.

In addition, the sound information collection unit 150 collects sounds around the user using the microphone of the user terminal and transmits sound information to the emergency report message transmission unit 160.

The emergency report message transmission unit 160 transmits the emergency report message and the sound information to the server 200.

When the user wants to make a direct call with a police officer, who is a subject who receives an emergency message, the report content generation unit 140 performs an automatic call connection.

<Case of Foreign Resident>

In the case of a foreign resident, the foreign resident may set his or her native language as a service providing language through the user environment setting unit 120 and utilize the emergency report service in his or her native language.

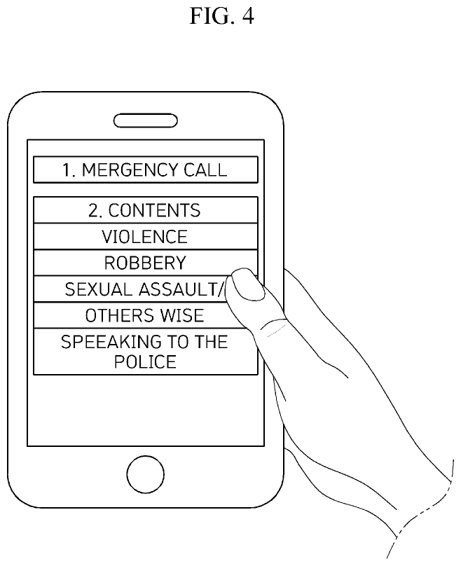

For example, when the foreign resident sets English as the service providing language, the user terminal provides the report and additional report content in English, as illustrated in FIG. 4.

Further, when the foreign resident wants to make a direct call, personnel, who can speak the corresponding language, in the National Police Agency, answer the corresponding call.

When there are no personnel who can speak the corresponding language, an artificial intelligence-based translator may be used to communicate directly with field personnel or to transmit or receive text messages to or from the field personnel.

The emergency report message reception unit 210 receives the sound information collected by the sound information collection unit 150, and a sound data analysis unit 230 stores the sound information in a database 240 and transmits the sound information to the emergency situation information detection unit 250.

The emergency situation information detection unit 250 analyzes the sound information in real time using an artificial intelligence algorithm and determines whether there is any abnormal sign.

As the artificial intelligence algorithm, a machine learning-based algorithm, such as a recurrent neural network (RNN), a convolutional neural network (CNN), or the like, or another artificial intelligence-based sound analysis algorithm may be used.

The emergency situation information detection unit 250 analyzes the sound information using the artificial intelligence algorithm and detects abnormal signs such as screams (e.g., “Aw,” “Ouch,” “It's a thief,” etc.), help request sounds (e.g., “Please save me,” Please help, etc.), threatening sounds, etc.

When the emergency situation information detection unit 250 detects the abnormal sign, the emergency situation information detection unit 250 transmits abnormal sign information and sound information related to the abnormal sign to the notification unit 260 and transmits the abnormal sign information and the sound information related to the abnormal sign to a person in charge of a system of the National Police Agency, a police station around the reporter, and a police patrol unit.

The person in charge of the system of the National Police Agency, a police officer of the police station around the reporter, or security personnel of the police patrol unit determines whether to dispatch using the sound information transmitted through the user terminal and using the abnormal sign information analyzed by the server.

The sound information, the emergency report message, and result report information after the dispatch to the field are stored in the database 240 after performing de-identification of personal information, and the server 200 analyzes and uses the validity of the report call, the accuracy of the analyzed sound information, and the like as additional information when receiving a report message later.

FIG. 2 illustrates an example of reporting by a hearing-impaired person according to an embodiment of the present invention.

The hearing-impaired person inputs a hearing impairment environment in advance and performs a text-based report in an emergency situation.

When performing text-based report, the user may briefly inform a subject, who receives a report, of his or her situation by clicking the “1. Report immediately” button that is displayed on the user terminal and clicking the “2. Additional report content” button depending on the situation to select emergency situation information.

Further, when the user is in a situation in which the user can input a text message, the user clicks the “Report by text” button, inputs his or her situation in the text message, and informs the subject of his or her situation in detail.

After receiving the report message, the police officer, who is the subject who receives the report, obtains sound information around the user collected using the microphone of the user terminal.

The server analyzes the sound information around the user through artificial intelligence-based sound information analysis and identifies the emergency situation of the user.

According to a result of the analyzing the report message and the sound information, police personnel suitable for the report are dispatched.

FIG. 3 illustrates an example of reporting by a visually-impaired person according to an embodiment of the present invention.

The visually-impaired person inputs a visual impairment environment in advance and performs a report based on physical button input in an emergency situation.

The activation of the emergency report function is set according to the user's convenience. For example, when clicking the power button three times consecutively or clicking the home button five times consecutively, the emergency report starts.

When the emergency report function is activated, the user terminal may provide vibration or a specific sound to notify that the emergency report function is activated, and may transmit the additional report content through an input of a specific pattern.

The police officer, who is the subject who receives the report, receives the report message and obtains sound information around the user collected using the microphone of the user terminal.

The server analyzes the sound information around the user through artificial intelligence-based sound information analysis and identifies the emergency situation of the user.

According to a result of the analyzing of the report message and the sound information, police personnel suitable for the report are dispatched.

When the user can make a direct call, a pattern for a call connection request is input so that a direct call connection is performed with the subject who receives the report, and thus the emergency situation may be notified through a voice call.

FIG. 4 illustrates an example of reporting by a foreign resident according to an embodiment of the present invention.

The foreign resident may set his or her native language as a language in a usage environment in an emergency report application.

Accordingly, after clicking an emergency report button displayed in his or her native language on the user terminal in a dangerous situation, the foreign resident may select emergency situation information displayed in the native language or make a call connection to communicate with the subject who receives the report and can speak the corresponding language.

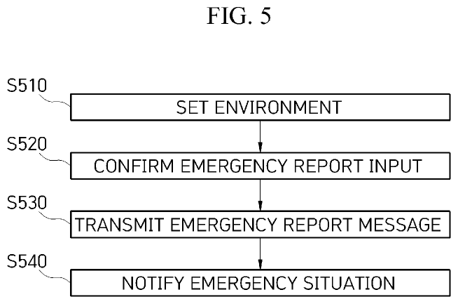

FIG. 5 is a flowchart of an emergency reporting method for the socially disadvantaged according to an embodiment of the present invention.

The emergency reporting method for the socially disadvantaged according to the embodiment of the present invention includes an operation S510 of receiving emergency report environment setting information of the socially disadvantaged, an operation S520 of receiving an emergency report input in a preset manner according to the emergency report environment setting information, an operation S530 of generating an emergency report message according to the emergency report input and transmitting the emergency report message, and an operation S540 of receiving the emergency report message and notifying a subject, who receives a report, of an emergency situation.

In operation S530, sound information is generated by collecting sounds generated in the vicinity of the socially disadvantaged, and the emergency report message including the sound information is transmitted.

In operation S540, the sound information included in the emergency report message is analyzed using artificial intelligence, and abnormal sign information corresponding to a result of the analysis is transmitted to notify the subject of an emergency situation.

In the case of a hearing-impaired person, when emergency report environment setting information of the hearing-impaired person is set in operation S510, in operation S520, an emergency report screen including buttons that are displayed as text is provided, and the buttons include an immediate report button and additional report content buttons.

In operation S520, a text report button is provided among the additional report content buttons to receive the emergency report input based on a text message.

In the case of a visually-impaired person, when emergency report environment setting information of the visually-impaired person is set in operation S510, in operation S520, when a preset physical button input is input, an emergency report function is activated and the emergency report input is received through a preset pattern input.

In operation S530, the emergency report message including emergency situation type information is generated using the preset pattern input which is input in operation S520, and when a pattern for a call connection request is input in operation S520, a call connection with field personnel is requested.

In the case of a foreign resident, when emergency report environment setting information of the foreign resident is set in operation S510, in operation S520, an emergency report screen including buttons displayed as text translated into a language used, and the buttons include an immediate report button and additional report content buttons.

When a call connection request in the emergency report screen is input in operation S520, in operation S540, a call connection is requested from personnel who can speak the language used, and an emergency situation is notified.

Meanwhile, the emergency reporting method for the socially disadvantaged according to the embodiment of the present invention may be implemented in a computer system or recorded on a recording medium. The computer system may include at least one processor, a memory, a user input device, a data communication bus, a user output device, and a storage. The above-described components perform data communication through the data communication bus.

The computer system may further include a network interface coupled to a network. The processor may be a central processing unit (CPU) or a semiconductor device that processes instructions stored in the memory and/or the storage.

The memory and the storage may include various types of volatile or nonvolatile storage media. For example, the memory may include a read only memory (ROM) and a random access memory (RAM).

Therefore, the emergency reporting method for the socially disadvantaged according to the embodiment of the present invention may be implemented as a computer-executable method. When the emergency reporting method for the socially disadvantaged according to the embodiment of the present invention is performed in a computer device, computer-readable instructions may perform the emergency reporting method for the socially disadvantaged according to the present invention.

Meanwhile, the emergency reporting method for the socially disadvantaged according to the present invention described above may be implemented as computer readable code in a computer-readable recording medium. The computer-readable recording medium includes any type of recording medium in which data that can be decoded by a computer system is stored. For example, a ROM, a RAM, a magnetic tape, a magnetic disk, a flash memory, an optical data storage device, and the like may be exemplified. In addition, computer-readable recording media may be distributed in computer systems connected through a computer communication network and may be stored and executed as code that can be read in a distributed manner.

According to the present invention, by providing a reporting system and method for the socially disadvantaged who are vulnerable in the case of security reporting or the like, it is possible to effectively transmit a report message to the National Police Agency or the like when the socially disadvantaged, such as the visually impaired, the hearing impaired, foreigners residing in Korea, and the like, are in an emergency situation, and it is possible to protect the lives and property of the socially disadvantaged.

Effects of the present invention are not limited to the above-described effects and other effects which have not been described may be clearly understood by those skilled in the art from the above detailed descriptions.

What is claimed is:

1. An emergency reporting system for the socially disadvantaged, the emergency reporting system comprising:
a user terminal configured to receive an emergency report input in a preset manner according to environment information set by the socially disadvantaged, generate an emergency report message, and transmit the emergency report message; and
a server configured to receive the emergency report message and transmit a dispatch notification signal.

2. The emergency reporting system of claim 1, wherein the user terminal transmits sound information collected using surrounding sounds thereof to the server.

3. The emergency reporting system of claim 2, wherein the server analyzes the sound information using artificial intelligence to generate abnormal sign information.

4. The emergency reporting system of claim 1, wherein the user terminal provides an emergency report screen including buttons that are displayed as text according to a user environment set by a hearing-impaired person, and the buttons include an immediate report button and additional report content buttons.

5. The emergency reporting system of claim 4, wherein, when a text report button is clicked among the additional report content buttons, the user terminal transmits the emergency report message including a written text message.

6. The emergency reporting system of claim 1, wherein, when a preset physical button input is input according to a user environment set by a visually-impaired person, the user terminal activates an emergency report function and generates the emergency report message according to the preset pattern input.

7. The emergency reporting system of claim 6, wherein the user terminal generates the emergency report message including emergency situation information according to an input of a pattern that is set for each emergency situation type.

8. The emergency reporting system of claim 6, wherein the user terminal performs an automatic call connection with field personnel according to an input of a pattern that is set as a call connection request.

9. The emergency reporting system of claim 1, wherein the user terminal provides an emergency report screen including buttons that are displayed as text translated into a language used according to a user environment set by a foreigner, and the buttons include an immediate report button and additional report content buttons.

10. The emergency reporting system of claim 9, wherein, when a call connection request is input among the additional report content buttons, the user terminal requests a call connection from the server and the server connects a call to personnel who have an ability to speak the language used.

11. An emergency reporting method for the socially disadvantaged, the emergency reporting method comprising:
an operation (a) of receiving emergency report environment setting information of the socially disadvantaged;
an operation (b) of receiving an emergency report input in a preset manner according to the emergency report environment setting information;
an operation (c) of generating an emergency report message according to the emergency report input and transmitting the emergency report message; and
an operation (d) of receiving the emergency report message and notifying a subject, who receives a report, of an emergency situation.

12. The emergency reporting method of claim 11, wherein, in the operation (c), sound information is generated by collecting sounds generated in the vicinity of the socially disadvantaged, and the emergency report message including the sound information is transmitted.

13. The emergency reporting method of claim 12, wherein, in the operation (d), the sound information included in the emergency report message is analyzed using artificial intelligence, and abnormal sign information corresponding to a result of the analysis is transmitted to notify the subject of the emergency situation.

14. The emergency reporting method of claim 11, wherein, when emergency report environment setting information of a hearing-impaired person is set in the operation (a), in the operation (b), an emergency report screen including buttons that are displayed as text is provided, and the buttons include an immediate report button and additional report content buttons.

15. The emergency reporting method of claim 14, wherein, in the operation (b), a text report button is provided among the additional report content buttons to receive the emergency report input including a text message.

16. The emergency reporting method of claim 11, wherein, when emergency report environment setting information of a visually-impaired person is set in the operation (a), in the operation (b), when a preset physical button input is input, an emergency report function is activated, and the emergency report input is received through a preset pattern input.

17. The emergency reporting method of claim 16, wherein, in the operation (c), the emergency report message including emergency situation type information is generated using the preset pattern input which is input in the operation (b), and when a pattern for a call connection request is input in the operation (b), a call connection with field personnel is requested.

18. The emergency reporting method of claim 11, wherein, when emergency report environment setting information of a foreigner is set in the operation (a), in the operation (b), an emergency report screen including buttons that are displayed as text translated into a language used is provided, and the buttons include an immediate report button and additional report content buttons.

19. The emergency reporting method of claim 18, wherein, when a call connection request in the emergency report screen is input in the operation (b), in the operation (d), a call connection is requested from personnel who have an ability to speak the language used, and the emergency situation is notified.
